(19) United States
(12) Patent Application Publication
(10) Pub. No.: US 2010/0215176 A1
(43) Pub. Date: Aug. 26, 2010

(54) Means and method for controlling the distribution of unsolicited electronic communications

(76) Inventor: Stephen Wilson, New South Wales (AU)

Correspondence Address: CHRISTIE, PARKER & HALE, LLP, PO BOX 7068, PASADENA, CA, 91109-7068, US

(21) Appl. No.: 11/921,966

(22) PCT Filed: Jun. 9, 2006
(86) PCT No.: PCT/AU2006/000803

§ 371 Date: Jun. 11, 2008

(30) Foreign Application Priority Data
Jun. 10, 2005 (AU) 2005903062
Oct. 14, 2005 (AU) 2005905707
Oct. 27, 2005 (AU) 2005906168

(51) Int. Cl. H04L 9/32

(52) U.S. Cl. 380/255

(57) ABSTRACT

Methods, devices, and systems for controlling distribution of unsolicited electronic communications such as bulk email or internet telephony telemarketing calls. A first Public Key (56) of a trusted accrediting body (10) is stored in a storage device (50) of a receiver (1), the trusted accrediting body (10) being trusted by the receiver (1). A sender (40) is issued a second Public Key (79) which chains back to the first Public Key (56). The sender (40) sends an unsolicited communication (62, 64), accompanied by a digital signature corresponding to the second Public Key (79). The receiver (1) verifies the digital signature accompanying a received communication by referring to the first Public Key (56) via the second Public Key (79), and if the digital signature is verified, establishes that the unsolicited communication is not unwelcome.

### CROSS-REFERENCE TO RELATED APPLICATIONS

The present application claims priority from Australian Provisional Patent Application No 2005903062 filed on 10 Jun. 2005, Australian Provisional Patent Application No 2005905707 filed on 14 Oct. 2005, and Australian Provisional Patent Application No 2005906168 filed on 27 Oct. 2005, the contents of which are incorporated herein by reference.

### TECHNICAL FIELD OF THE INVENTION

This invention relates to unsolicited electronic communications, and in particular to differentiating between unwelcome unsolicited electronic communications, known as spam, and unsolicited electronic communications which are welcomed by the receiver. The invention makes use of receiver-side devices, for example removable cryptographic devices such as smartcards, to carry security information which enables confirmation of the endorsement by trusted umbrella organisations of certain senders of unsolicited communications.

### BACKGROUND ART

Unwelcome unsolicited electronic communications, such as bulk e-mails or spam, are a rapidly worsening problem. The increases in spam have lead to expensive network congestion and down-time, lost productivity as workers spend increasing amounts of time dealing with it, and unwelcome extra Internet connection costs, it generally being the receiver and not the sender who pays for e-mail transmission costs. In response to the problem, many new countermeasures have been designed to block spam, none of which are ideal. General disadvantages of current spam countermeasures include: added complexity in the relationship between sender and receiver; delays to the transmission of legitimate communications; inconvenience to the senders of legitimate communications; and/or inaccuracy in the blocking mechanism leading to leakage of spam or inadvertent blocking of legitimate messages. The major approaches which have been proposed to date to ward off spam are discussed further in the following.

One of the most popular approaches to dealing with spam is to attempt to intelligently detect and filter out spam, based on various characteristics. In particular, bulk commercial spam tends to feature common keywords or text constructions. Bayesian statistics and other analytical methods can be effective in detecting a majority of such forms of spam, for example as set out in U.S. Pat. No. 6,161,130 and U.S. Pat. No. 6,615,242. There is an inescapable shortcoming in all intelligent filters however, namely their finite accuracy. Inevitably, any filter will exhibit both false positives (legitimate messages classified as spam and filtered out) and false negatives (spam that is not classified as such and is not filtered). In practice, spam filters are commonly biased towards false negatives, so as not to block too many legitimate messages, and this leads to spam leaking through the filter to some degree.

Another class of anti-spam measures involve a “White List” of accepted senders, against which the origin of incoming messages is checked, and only those that can be matched against the list are allowed through. However, the creation and maintenance of White Lists represents an added burden on the receiver's software, and large White Lists can impede the processing of incoming mail. Further, rebuilding a White List after a system crash or operating system upgrade can be time consuming, and White Lists will not always port readily from one e-mail system to another.

A further approach to filtering unwanted spam is to impose a “Challenge-Response” system, such systems automatically responding to incoming suspected spam with a prompt for the sender to take a defined additional action before the system will allow the message through. See for example U.S. Pat. No. 6,546,416. This type of approach usually works against bulk emails because automatic senders usually are not sophisticated enough to process the return message. Challenge-Response systems however are not ‘friendly’ to legitimate senders and inevitably delay at least the first message from a hitherto unknown sender. Some Challenge-Response systems automatically generate a White List of accepted senders, however as discussed in the preceding, the White List has its own problems.

Yet another class is the “Black List” anti-spam solutions, which involve lists of senders that are known to be offenders and blocking all messages originated by those offenders. A Black List can be built up in response to complaints from users, as set out in U.S. Pat. No. 6,748,422. As with White Lists, Black Lists add complexity to messaging systems, entail a significant workload to update and maintain, and can have interoperability problems, especially at their current early stage of evolution.

Some anti-spam proposals call for a financial commitment from the sender before messages are delivered. In U.S. Pat. No. 6,697,462 for instance, there is payment of a bond which is forfeited in the event the receiver resents the subsequent communications.

Various further spam countermeasures feature an extra centralised server or some form of intermediary sub-system which effects blocking functions. See for example U.S. Pat. No. 6,650,890. The common problem of all such approaches is that they impose additional process steps and potential bottlenecks between sender and receiver.

Another proposal for countering spam involves the use of digital signatures, which can furnish reliable information about the origin of a message, and which can be analysed by the receiver's software in various ways to determine whether the message should be welcomed. For example, the receiver's software could contain a White List and/or a Black List of signatories. However, processing digital signatures in these ways brings the general disadvantages of White Lists and Black Lists described above.

The preceding problems and proposed solutions relating to bulk email (spam) control, apply similarly to other such forms of electronic communications, such as instant messaging and internet telephony communications.

In addition to the identified limitations of the preceding proposals, such proposals fail to address the need to differentiate between unwelcome unsolicited communications, and welcome unsolicited communications.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to a first aspect, the present invention provides a method for controlling distribution of unsolicited electronic communications, the method comprising:
storing in a storage device of a receiver a first Public Key of a trusted accrediting body, the trusted accrediting body being trusted by the receiver;
issuing to a sender a second Public Key, the second Public Key chaining back to the first Public Key;
the sender sending an unsolicited communication having an accompanying digital signature corresponding to the second Public Key;
upon the receiver verifying the received digital signature by reference to the first Public Key via the second Public Key, establishing that the unsolicited communication is not unwelcome.

According to a second aspect the present invention provides a system for controlling distribution of unsolicited electronic communications, the system comprising:
a storage device of a receiver, storing a first Public Key of a trusted accrediting body trusted by the receiver;
a sender having a second Public Key, the second Public Key chaining back to the first Public Key, and the sender being operable to send an unsolicited communication having an accompanying digital signature corresponding to the second Public Key; and
receiver means to verify the received digital signature by reference to the first Public Key via the second Public Key, and if verified to establish that the unsolicited communication is not unwelcome.

According to a third aspect the present invention provides a method of accrediting a sender in order to control distribution of unsolicited electronic communications, the method comprising issuing to the sender a second Public Key, wherein a trusted accrediting body is trusted by a receiver, and wherein the second Public Key chains back to a first Public Key of the trusted accrediting body stored by a storage device of the receiver.

According to a fourth aspect the present invention provides a system for accrediting a sender in order to control distribution of unsolicited electronic communications, the system comprising means for issuing to the sender a second Public Key, wherein a trusted accrediting body is trusted by a receiver, and wherein the second Public Key chains back to a first Public Key of the trusted accrediting body stored by a storage device of the receiver.

According to a fifth aspect the present invention provides a method of controlling receipt of an unsolicited electronic communication by a receiver, the method comprising:
retrieving from a storage device of the receiver a first Public Key of a trusted accrediting body, the trusted accrediting body being trusted by the receiver;
verifying by reference to the first Public Key a digital signature accompanying the unsolicited electronic communication, and if verified establishing that the unsolicited electronic communication is not unwelcome.

According to a sixth aspect the present invention provides a system for controlling receipt of an unsolicited electronic communication by a receiver, the system comprising:
means for retrieving from a storage device of the receiver a first Public Key of a trusted accrediting body, the trusted accrediting body being trusted by the receiver;
means for verifying a digital signature accompanying the unsolicited electronic communication by reference to the first Public Key, and if verified, for establishing that the unsolicited electronic communication is not unwelcome.

According to a seventh aspect the present invention provides a computer program for controlling receipt of an unsolicited electronic communication by a receiver, the computer program comprising:
code for retrieving from a storage device of the receiver a first Public Key of a trusted accrediting body, the trusted accrediting body being trusted by the receiver;
code for verifying a digital signature accompanying the unsolicited electronic communication by reference to the first Public Key, and if verified, for establishing that the unsolicited electronic communication is not unwelcome.

The present invention recognises that, in dealing effectively with the problem of unsolicited messages such as spam, it must be considered that some unsolicited messages are in fact welcome, even if the sender has no direct prior relationship with the receiver, and ideally should not be blocked. Examples of such useful unsolicited e-mails can include: invitations to examine or buy new offers from providers with a close relationship to a user's existing contracted service providers (for instance, a bank customer might receive an insurance offer from a financial institution allied to the bank); free newsletters from organisations affiliated with a user's existing associations, clubs and so on; public interest information disseminated by government agencies; and other direct marketing material where there is good reason to believe the recipient will in fact be interested in the content and therefore welcome it, at least on a trial basis.

Of relevance in the general background to the present invention is the increasing practice of contracted service providers asking their customers to consent to the sharing of customer contact details with selected third party distributors of unsolicited communications, on the basis that said communications can be presumed to be welcome in the customers' general context. This practice confirms that in many cases, select types of unsolicited communications are indeed welcome.

Accordingly, in embodiments of the present invention, the sender may comprise one or more of: a provider with a close relationship with the trusted accrediting body; an organisation affiliated with the trusted accrediting body; a club or society for customers of or persons associated with the trusted accrediting body; a source of public interest information related to the trusted accrediting body; and a source of direct marketing material relevant to or associated with the trusted accrediting body.

The present invention requires senders of unsolicited messages to apply digital signatures to their messages, or alternatively requires cryptographic authentication codes to be created for messages and verified using chained Public Key certificates. Embodiments of the present invention may provide a new, convenient, efficient, and secure means to process the digital signature at the receiving end. Further, embodiments of the present invention provide for the trusted accrediting organisation to act on behalf of their members, or on behalf of receivers who trust the accrediting body for this purpose, to endorse or accredit said senders. The invention is thus not reliant upon White Lists or Black Lists, and may further relieve the receiver of the burden of spending valuable time considering potential senders of unsolicited messages and endorsing or rejecting them individually.

The storage device of the receiver may comprise a magnetic disk or random access memory of a computing device of the receiver. For example, the first Public Key may be stored in a Trust List holding one or more trusted public keys stored in such a storage device, such as a Trust List for access by email, communications, or web browser software of the computing device.

In more preferred embodiments, use is made of portable cryptographic devices, such as smartcards, as the storage device of the receiver. Such embodiments of the present invention recognise that such portable storage devices, being cryptographic, provide increased security against malicious substitution of the first public key should it be held in a Trust List on a magnetic disk or the like. Embodiments utilising portable cryptographic devices further recognise that such devices are already increasingly being issued to communities or groups of users by trusted umbrella organisations. Such embodiments of the present invention may thus exploit such issued devices by providing means for those umbrella organisations to themselves endorse or accredit senders of unsolicited messages, on behalf of their respective communities or groups of users.

While in preferred embodiments of the invention the portable storage device comprises a smartcard, it is to be appreciated that in alternate embodiments of the invention the portable storage device may comprise a magnetic stripe card, a USB drive with or without cryptographic functionality, a CD-ROM, a subscriber identification module (SIM); a personal data assistant, or other type of storage device whether with or without cryptographic functionality.

The computing device using the first Public Key in accordance with the present invention may comprise a personal computer, a laptop computer, a network-enabled device such as a BlackBerry™, a mobile telephone handset, a VOIP phone, or other such device.

In more detail, some embodiments of the present invention recognise the situation where a trusted umbrella organisation, representative of a community of interest, can for a variety of reasons issue smartcards or functionally similar removable cryptographic devices to members of that community. Examples of such umbrella organisations include without limitation financial institutions, government agencies such as health departments, and professional associations. Uses of such smartcards can include without limitation secure card holder identification, physical access control, logical access control, credit and debit services, the storage of personal biometric information, loyalty programme management, and so on. The present invention recognises that the umbrella organisation is often able to function as a trusted accrediting body, as the umbrella organisation is likely to be in a good position to adjudge the usefulness of certain types of unsolicited communications to the members of the organisation's community of interest, and to therefore endorse certain distributors of such communications.

Examples of umbrella organisations who may serve as a trusted accrediting body in accordance with the present invention include without limitation: a financial institution which could endorse affiliated insurance companies wishing to send promotional materials, new product offers and so on to customers of said institution; a health department which could endorse public health organisations which wish to disseminate educational materials; a professional association which could endorse “sister” associations, special interest publishers, conference organisers and so on, which wish to target direct marketing to selected sectors; and an operator of a card-based retail loyalty programme which could endorse a range of merchants which have an interest in direct marketing to members of said programme.

Embodiments of the present invention may further offer the advantage that an umbrella organisation which is to function as a trusted accrediting body in accordance with the present invention and which issues smartcards or functionally similar removable cryptographic devices to users or receivers forming a community of interest can, with very little additional cost, arrange for a copy of at least a first Public Key Certificate to be securely stored on said cryptographic devices, whether before or after such devices are issued to each receiver. Such embodiments of the present invention further rely on the trusted accrediting body issuing (or having issued on its behalf) a second Public Key Certificate to an endorsed sender of unsolicited communications, such that said second Public Key Certificate chains back to the first Public Key stored on said cryptographic devices. Thus, digitally signed messages or data objects originating from the endorsed sender and received and processed by a receiver having a removable cryptographic device issued by the trusted accrediting body will be found to chain back to the trusted first Public Key on said device and can therefore be taken to be not unwelcome.

Accordingly, the present invention provides for a level of control of the distribution of unsolicited electronic communications. Embodiments of the invention may enable umbrella organisations to act as a trusted accrediting body on behalf of communities of users to endorse third party distributors of unsolicited communications (such as relevant direct marketing materials, related professional communications, or new offers from affiliated retailers).

The present invention may be applied in respect of electronic communication systems in which a digital signature can accompany a communication. For example, embodiments of the invention may be applied in respect of email communications, instant messaging communications, internet protocol (IP) telephony communications such as voice over IP (VOIP), short message service (SMS) communications, or other such types of electronic communications.

Upon verifying the digital signature accompanying an unsolicited communication by referring to the first Public Key via the second Public Key, some embodiments of the invention may provide for further management of the unsolicited communication. For example, where the unsolicited communication is determined to be not unwelcome, the communication may be presented to a user with an indication that the communication is unsolicited and is from an accredited source. For example, where the communication is email, each unsolicited email message which is not unwelcome may be delivered to the receiver's primary inbox. Where any digital signature accompanying an unsolicited electronic communication is not verified by reference to the first Public Key via the second Public Key, embodiments of the invention may provide for the unsolicited communication to be deleted, or in the case of email communications may provide for the unsolicited message to be delivered to a ‘junk’ inbox.

### BRIEF DESCRIPTION OF THE DRAWINGS

By way of example only, preferred embodiments of the invention will be described with reference to the accompanying drawings, in which:

FIG. 1 is a block diagram representing the issuance of smartcards by an Association to its Members, and use of said smartcards to secure e-mails and data objects sent by said Association to its Members;

FIG. 2 is a schematic illustration of the Public Key Certificate chain of the Association;

FIG. 3 is a block diagram representing the relationship between the Association and a third party Distributor of unsolicited communications; and

FIG. 4 is a schematic illustration of the Public Key Certificate chain of FIG. 2 extended to include a Public Key Certificate issued to the endorsed Distributor.

### DETAILED DESCRIPTION OF THE PREFERRED EMBODIMENTS

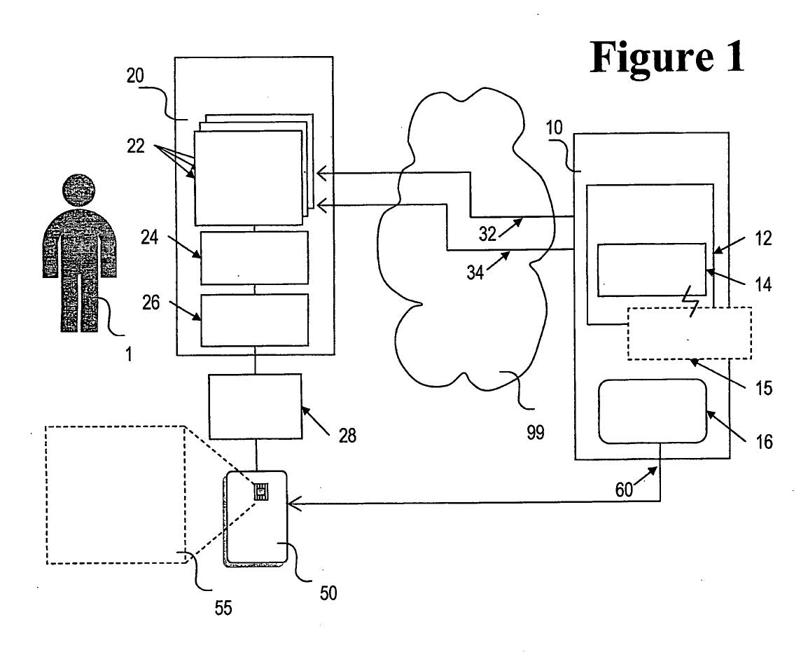

Turning now to FIG. 1, an association 10 issues a smartcard 50 to a member 1 of the association 10. The association 10 sends secure communications to member 1 over a communications network 99 using messaging services software 12 running at the association 10, and one or more messaging clients 22 running on the computer 20 of the member 1 are used to receive the secure communications. The messaging clients 22 can without limitation include web browser, e-mail, IP telephony and/or special purpose messaging software written by or on behalf of the association 10. In a preferred embodiment, messaging clients 22 interface to the smartcard 50 via a standard smartcard reader 28, smartcard reader driver software 26 and a standard cryptographic application programming interface (API) 24.

Still referring to FIG. 1, two types of low level electronic business security function are illustrated, either or both of which are utilised by the messaging clients 22 to authenticate communications sent by the Association 10 and its Member 1, as follows. First, a secure e-mail link 32 is implemented, in which digital signatures are applied to messages created by association 10, and subsequently verified by one of the messaging clients 22 with the assistance of one or more Public Keys 55, such Public Keys including without limitation one or more Root Public Key Certificates, and/or one or more Association Public Key Certificates. Copies of the Public. Keys 55, in a preferred embodiment, are securely stored in Smartcard 50. Second, a secure signed objects link 34 is also implemented, in which data objects such as data files or executable programs forwarded by association 10 are digitally signed by the association 10, and before being used by member 1, are checked using standard object signing verification functions in the operating system of the computer 20, which can check the veracity and integrity of said data objects before the objects are installed.

It is to be appreciated that messaging services 12 will make use of one or more digital signing functions 14 in order to create and attach digital signatures to said secure e-mail 32 and/or signed objects 34. Digital signing functions 14 make use of cryptographic Private Keys (not shown) each of which is uniquely associated with a corresponding Public Key Certificate. In FIG. 1, a first Public Key Certificate 15 issued to association 10 is shown in relation to the digital signing function 14 used by the association 10. Copies of the first Public Key Certificate 15 are utilised by messaging client software 22 by all members, such as member 1, of the Association 10.

In a preferred embodiment, and still referring to FIG. 1, the smartcard 50 is pre-loaded by or on behalf of the association 10 with one or more Public Key Certificates 55, all held in the smartcard's tamper resistant memory. Note that in the interests of brevity, the processes and elements involved in creating and loading Public Key Certificates are not shown in FIG. 1, as said processes and elements will be understood by one skilled in smartcard technology and public key technology. Said Public Key Certificates 55 can include without limitation any or all of the following: a copy of the Root Public Key Certificate of each trusted certificate issuer used by the association 10, available to be used by messaging clients 22 to verify digital signatures in general which chain back to said Roots; a copy of a Public Key Certificate to be used to verify digital signatures on secure e-mails 32 sent by the association 10 to member 1; and a copy of a Public Key Certificate to be used to verify digital signatures on signed objects 34 sent by the association 10 to member 1.

Alternative embodiments of the present invention may store the Public Key of the association 10 in a storage device other than a cryptographic smartcard, whether a portable storage device such as USB memory or CD-ROM, or a non-portable storage device such as a magnetic hard disk drive of a personal computer of the member 1. The storage device may optionally have cryptographic functionality.

However, use of the cryptographic smartcard 50 is preferred in the embodiment of FIG. 1 and, before describing the present invention further, it is appropriate to first review the benefits of smartcards, being exemplary examples of removable cryptographic devices, and their general status in practice. Smartcards are increasingly commonplace for a number of reasons, most particularly for protection against personal identity theft perpetrated against customers of financial institutions, government agencies and so on. Compared with magnetic stripe cards, smartcards and functionally similar removable cryptographic devices are very difficult to illicitly duplicate.

The information held within the internal memory of a “smart” cryptographic device generally cannot be accessed or activated without the proper authorisation (as typically evidenced by presenting a correct personal identification number or PIN to the device). In some cryptographic devices, certain data such as cryptographic Private Keys, are prevented by the device's internal operating system from ever being transmitted from the device. Such a cryptographic device cannot be duplicated by an attacker even if the attacker has gained knowledge of a PIN. These properties of removable cryptographic devices (and in particular smartcards) in effect make them highly resistant to “skimming”, being the form of identity theft where conventional magnetic stripe cards are illicitly duplicated by copying data directly from one card's stripe onto another's.

The rollout of smartcards and other functionally similar removable cryptographic devices is now being expedited by steadily enhanced levels of support in standard Internet software, operating systems and commercial computer hardware. Credit card companies have announced that in future, magnetic stripe card technology must be replaced by smartcard technology. Therefore, customers of online institutions, especially financial institutions, will in future carry smartcards or other functionally similar removable cryptographic devices with which to authenticate themselves for access to electronic business services.

As of mid-2005, in excess of three hundred million smartcards had been issued worldwide to retail customers of banks and other financial institutions. Other important contemporary smartcard programmes include:
healthcare schemes, both public and private, where individuals are issued smartcards which carry entitlement information, and carry unique identifiers for indexing electronic health records, and in some cases, carry a limited set of personal health status information for use by medical practitioners in a variety of settings; and
government id and licensing schemes, where a smartcard (often bearing a photograph of the holder) is used to positively identify an individual and such rights as being licensed to drive a car.

As disclosed in Australian Patent No. 2004100268 and corresponding International Patent Application No. PCT/AU2005/000522 (WO 2005/098630), the content of each of which is incorporated herein by reference, smartcards and functionally similar removable cryptographic devices can not only protect card holders from identity theft by carrying the holder's Private Keys; these devices can also protect their issuer from impersonation by carrying one or more Public Keys associated with the issuer. Cryptographic Public Keys act like ‘master keys’ and are required by standard security algorithms for the validation of incoming encrypted data. Traditionally, copies of the requisite Public Keys are held in computer disk memory and are loaded with Internet software. However, when stored in this way, Public Keys can be surreptitiously substituted by hackers, leading to a number of forms of identity fraud. It is more preferable to store copies of Public Keys in tamper proof removable cryptographic devices.

One of the features of aforementioned International Patent Publication No. WO 2005/098630 is a means for delivering secure, authenticated messages from the issuer of a removable cryptographic device, to the holders of said devices, so as to ward off counterfeit mail or “phishing”. This technique relies on the chaining of Public Key Certificates. Public Key Certificates chain together, such that each certificate is digitally signed by a Private Key matched to another Public Key Certificate, one step further up the chain. The chain terminates with a self signed “Root” certificate, a faithful copy of which must be available to the receiving end software. International Patent Publication No. WO 2005/098630 provides for an issuer of smartcards to have loaded onto the smartcards one or more Public Keys with which the issuer is associated. In this manner, e-mails or other data objects digitally signed by the issuer can be automatically verified by card holders, and thus reliably distinguished from phishing.

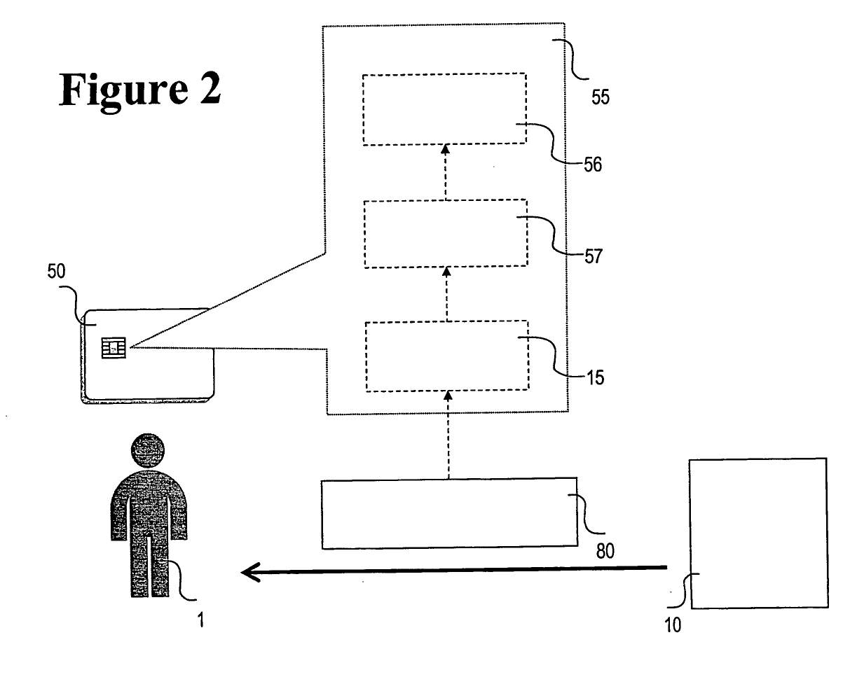

FIG. 2 illustrates in schematic form the relationships between various Public Key Certificates stored on the smartcard 50, and digitally signed data 80, which might include without limitation signed e-mail, signed objects, or signed IP telephony packets or headers, sent by the association 10 to the member 1. Public Key Certificates chain together, so that an algorithm which checks the validity of a given Public Key Certificate will use as input another Public Key Certificate one step further up the chain. Still referring to FIG. 2, digitally signed data 80 is validated by software (not shown) of member 1, in step-wise fashion, by first checking the digital signature on said data against the first Public Key Certificate 15 of the association 10, and then checking the digital signature on said first Public Key Certificate 15 against an Intermediate Public Key Certificate 57, and finally checking the digital signature on said Intermediate Public Key Certificate 57 against a Root Public Key Certificate 56.

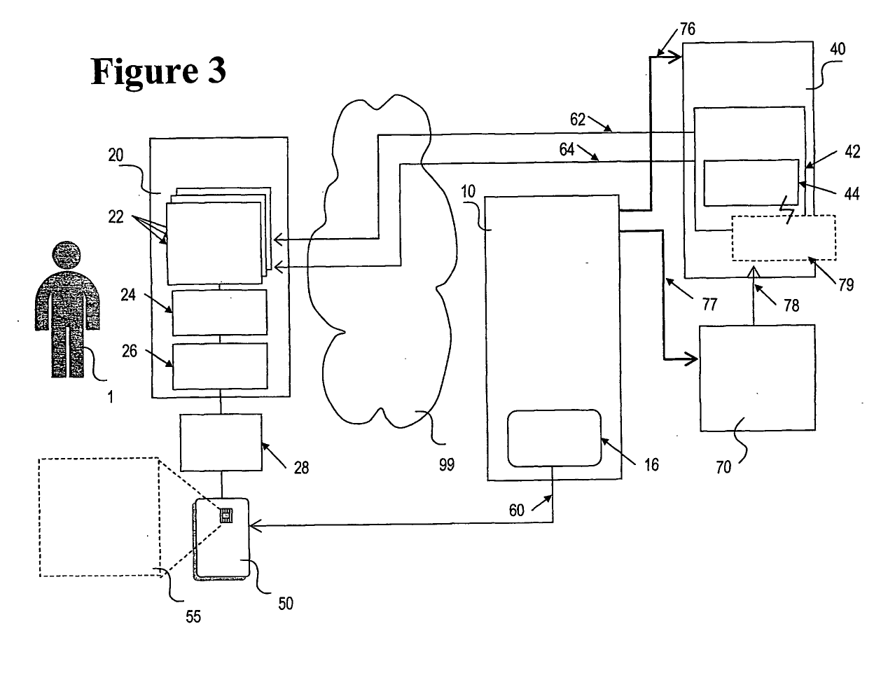

Now referring to FIG. 3, in which like reference numerals indicate like features of other Figures, association 10 is shown conferring endorsement or accreditation 76 on a sender comprising third party distributor 40, such that the distributor can subsequently send unsolicited (but deemed to be not unwelcome) communications to member 1, said communications including without limitation secure e-mail 62 and signed objects 64. Said endorsement is effected in the present invention by the association 10 requesting 77 that a certification authority 70 issues at 78 a Public Key Certificate 79 to endorsed distributor 40, such that said Public Key Certificate 79 chains to a Root Public Key Certificate, a faithful copy of which is already held by member 1. In a preferred embodiment, the copy of said Root Public Key Certificate is stored within the tamper resistant smartcard 50. Said Root Public Key Certificate may or may not be the same Root Public Key Certificate to which the association's Public Key Certificate 15 chains. Purely for simplicity, the figures show the same Root Public Key Certificate 56 being implemented at the top of the certificate chain for both the association 10 and the endorsed distributor 40.

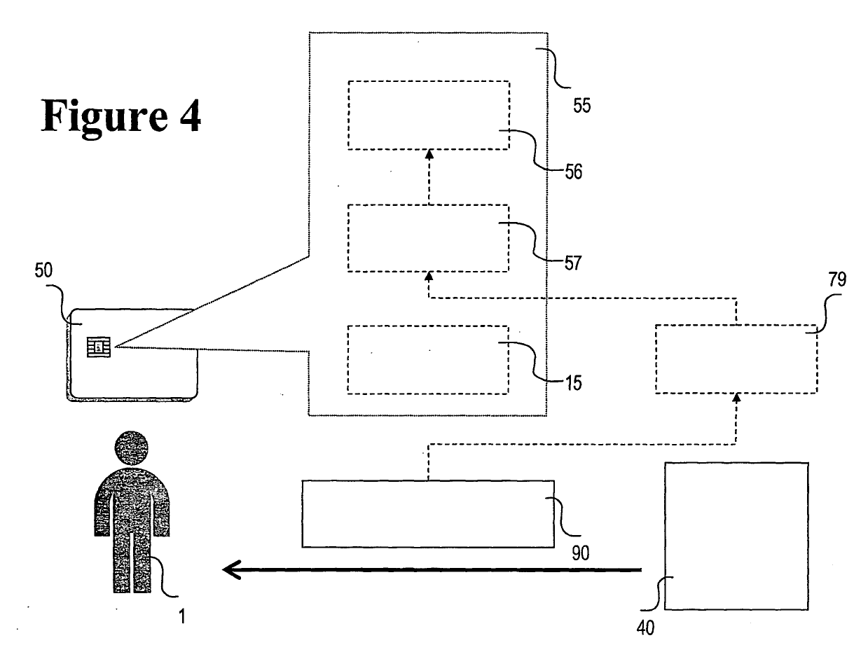

Finally, FIG. 4 illustrates in schematic form how Public Key Certificate 79 of endorsed distributor 40 relates to the other Public Key Certificates stored on the smartcard 50, and to digitally signed data 90 sent by said endorsed distributor 40 to member 1, so that it may be understood how the endorsement by the association 10 of the distributor 40 is put into effect. Still referring to FIG. 4, when digitally signed data or communications 90 is validated by software (not shown) of member 1, said software will find that the digital signature on said data chains to Public Key Certificate 79, which in turn chains to Intermediate Public Key Certificate 57 and finally to the Root Public Key Certificate 56. In this way, digitally signed data 90 from endorsed distributor 40 will be found by the software of member 1 to have originated from a sender or endorsed distributor 40 accredited by the trusted accrediting body or association 10, and thus the data 90 can be trusted by the member 1 as being closely associated with and endorsed by the accrediting body 10.

It should be noted that while in the present embodiment Public Key Certificates 15, 57 and 56 are all stored in the tamper resistant smartcard 50, it is not necessary for Public Key Certificate 79 of endorsed distributor 40 to be so stored. Rather, as with many conventional digital signature applications, Public Key Certificate 79 may be stored in ‘soft’ form and made available to member 1 in a number of ways, including without limitation as data accompanying signed e-mail 62 or signed objects 64, or fetched from a public key directory (not shown). It is to be appreciated that the Public Key Certificate chain from signed data 90 back to the Root Public Key Certificate 56 can be safeguarded against attack by enforcing what are known as “Path Constraints”. For instance, Intermediate Public Key Certificate 57 could be issued to include a constraint that enforces no more than two chaining steps down to any subservient digitally signed data item.

Further, it is to be appreciated that the Public Key Certificate 79 is inherently resistant to attack by virtue of its digital signature chaining back to a faithful copy of the Root Public Key Certificate 56.

Not illustrated in the accompanying figures is the means and method of revocation of endorsed distributors, such as distributor 40. Such revocation may be effected by including in a receiver's software a function which checks for the possible revocation of any Public Key Certificate associated with the sender of digitally signed data. Thus, by following management processes and mechanisms by which the issuer 10 of removable cryptographic devices can disendorse a particular sender of unsolicited communications, future communications digitally signed by said disendorsed sender are readily recognised by receivers' software so that they may then be recognised as no longer being not unwelcome, and may be blocked.

Thus, the preferred embodiment of the present invention may improve the control of the distribution of unsolicited communications in one or more of the following ways:
users need not be concerned with endorsing distributors of potentially welcome unsolicited communications one by one, but instead can rely upon a trusted umbrella organisation endorsing distributors on their (the users') behalf;
responsible distributors of unsolicited communications do not need to seek endorsement of large numbers of individuals one by one, but instead can work with umbrella organisations to achieve endorsement on behalf of whole groups of target recipients;
user software with the capability of processing digital signatures using standard Public Key Certificates can be readily programmed to block unwelcome unsolicited communications found not to originate from endorsed distributors, with zero intervention from the user, and with better accuracy than intelligent spam filters;
in contrast to challenge-response approaches, there are no unnecessary delays to messages from previously unknown senders;
it is straightforward to endorse additional distributors, and to disendorse distributors; no actions at all are required by end users in either case;
a single technology and, in particular, a single Public Key Certificate chain per umbrella organisation, can be used in support of a wide range of cryptographic security protocols, including without limitation S/MIME and object signing, as well as customized public key based messaging systems.

It will be appreciated by persons skilled in the art that numerous variations and/or modifications may be made to the invention as described. It will be particularly appreciated that the present invention can be constructed using a variety of alternate components for the messaging software, the removable cryptographic devices or portable storage devices, readers for interfacing computer systems with removable cryptographic devices, and/or reader drivers, without materially affecting the efficacy of the invention in respect of its ability to control the distribution of unsolicited communications. Further, it will be realised that a variety of removable devices will be available with similar functions in respect of secure storage of cryptographic keys but packaged in different forms, including without limitation plastic cards with embedded integrated circuit chips, Universal Serial Bus (USB) tokens or “smart keys”, CD-ROMs, Subscriber Identification Modules (SIMs), removable hard disk drives, Personal Data Assistants, mobile or cellular telephones and the like, and that the present invention can be constructed from such alternate devices without departing from the scope or spirit of the invention.

Further, it will be realised that alternate Public Key Certificate chains may be implemented other than those described, wherein such alternates may involve a plurality of Root Public Key Certificates, with or without Intermediate Certificates, such alternates nevertheless involving new Public Key Certificates being issued to endorsed third party distributors which chain automatically to a Root Public Key Certificate, a faithful copy of which is held by an existing member of a trusted umbrella organisation. It will also be appreciated that the function of Certification Authority for the generation of Public Key Certificates can be implemented in a number of ways, including outsourcing, without departing from the scope of the present invention.

The sender of unsolicited communications may be a provider of, or a party associated with a provider of, anonymously indexed electronic records of the type set out in International Patent Application No. PCT/AU2005/000364, the content of which is incorporated herein by reference. The sender of unsolicited communications may additionally or alternatively be an issuer of, or a party associated with an issuer of, portable cryptographic devices of the type set out in International Patent Application No. PCT/AU2005/000364.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-87. (canceled)

88. A method for controlling distribution of unsolicited electronic communications, the method comprising:
storing in a storage device of a receiver a first Public Key of a trusted accrediting body, the trusted accrediting body being trusted by the receiver;
issuing to a sender a second Public Key, the second Public Key chaining back to the first Public Key;
the sender sending an unsolicited communication having an accompanying digital signature corresponding to the second Public Key; and
upon the receiver verifying the received digital signature by reference to the first Public Key via the second Public Key, establishing that the unsolicited communication is not unwelcome.

89. The method according to claim 88 wherein the digital signature comprises a cryptographic authentication code.

90. The method according to claim 88 wherein the storage device of the receiver comprises at least one of; a magnetic storage disk; and, random access memory of a computing device.

91. The method of claim 90 wherein the first Public Key is stored in a Trust List on the storage device.

92. The method according to claim 88 wherein the storage device is portable.

93. The method according to claim 88, wherein the storage device of the receiver comprises a cryptographic device.

94. The method of claim 92 wherein the storage device comprises at least one of a smartcard; a magnetic stripe card; a USB drive; a cryptographic USB drive; a CD-ROM; a personal data assistant; a subscriber identification module (SIM); a mobile telephone handset; a hardware security module (HSM) and a network-enabled device.

95. The method of claim 88 wherein the storage device is provided to the receiver by or on behalf of the trusted accrediting body.

96. The method according to claim 88 wherein the electronic communications comprise at least one of email communications, instant messaging communications, short message service (SMS) communications and internet protocol (IP) telephony communications.

97. A method of accrediting a sender in order to control distribution of unsolicited electronic communications, the method comprising issuing to the sender a second Public Key, wherein a trusted accrediting body is trusted by a receiver, and wherein the second Public Key chains back to a first Public Key of the trusted accrediting body stored by a storage device of the receiver.

98. The method according to claim 97 wherein the sender accompanies the unsolicited electronic communications with a digital signature corresponding to the second Public Key, and wherein the digital signature comprises a cryptographic authentication code.

99. A method of controlling receipt of an unsolicited electronic communication by a receiver, the method comprising:
retrieving from a storage device of the receiver a first Public Key of a trusted accrediting body, the trusted accrediting body being trusted by the receiver;
verifying by reference to the first Public Key a digital signature accompanying the unsolicited electronic communication, and if verified establishing that the unsolicited electronic communication is not unwelcome.

100. The method according to claim 99 wherein the digital signature comprises a cryptographic authentication code.

101. The method according to claim 99 wherein the storage device of the receiver comprises at least one of; a magnetic storage disk; and, random access memory of a computing device.

102. The method of claim 101 wherein the first Public Key is stored in a Trust List on the storage device.

103. The method according to claim 99 wherein the storage device is portable.

104. The method according to claim 99 wherein the storage device of the receiver comprises a cryptographic device.

105. The method of claim 103 wherein the storage device comprises at least one of a smartcard; a magnetic stripe card; a USB drive; a cryptographic USB drive; a CD-ROM; a personal data assistant; a subscriber identification module (SIM); a mobile telephone handset; a hardware security module (HSM) and a network-enabled device.

106. The method of claim 99 wherein the storage device is provided to the receiver by or on behalf of the trusted accrediting body.

107. A computer program for controlling receipt of an unsolicited electronic communication by a receiver, the computer program comprising:
code for retrieving from a storage device of the receiver a first Public Key of a trusted accrediting body, the trusted accrediting body being trusted by the receiver;
code for verifying a digital signature accompanying the unsolicited electronic communication by reference to the first Public Key, and if verified, for establishing that the unsolicited electronic communication is not unwelcome.
